(19) United States
(12) Patent Application Publication
(10) Pub. No.: US 2014/0279699 A1
(43) Pub. Date: Sep. 18, 2014

(54) FINANCIAL ADVISORY SYSTEM

(71) Applicant: Christopher Carosa, Honeoye Falls, NY (US)

(72) Inventor: Christopher Carosa, Honeoye Falls, NY (US)

(21) Appl. No.: 14/214,832

(22) Filed: Mar. 15, 2014

Related U.S. Application Data
(60) Provisional application No. 61/788,864, filed on Mar. 15, 2013.

(51) Int. Cl. G06Q 40/06

(52) U.S. Cl. CPC G06Q 40/06
USPC 705/36 R

(57) ABSTRACT

A system for providing investment metrics of an investment based on a multi-period time span, the system comprising a system for providing a first measure comprising a first ratio of the number of periods in which a return of the investment within the multi-period time span meets or exceeds a Goal Oriented Target (GOT) to the total number of periods within the multi-period time span and a system for providing a second measure comprising a second ratio of the total amount of surpluses within the multi-period time span to the total amount of surpluses and gaps within the total number of periods in the multi-period time span.

### PRIORITY CLAIM AND RELATED APPLICATIONS

This non-provisional application claims the benefit of priority from provisional application U.S. Ser. No. 61/788,864 filed on Mar. 15, 2013. Said application is incorporated by reference in its entirety.

### BACKGROUND OF THE INVENTION

1. The Field of the Invention

The present invention is directed generally to a financial advisory system. More specifically, the present invention is directed to a financial advisory system comprising a system for providing a measure of the percentage of time of an investment is meeting or exceeding a target and a measure of the likelihood of an investment recovering from not meeting such target.

2. Background Art

Over the past decade, American investors increasingly have turned to mutual funds to save for retirement and other financial goals. Mutual funds can offer the advantages of diversification and professional management. However, as with other investment choices, investing in mutual funds involves risk. Further, fees and taxes diminish a fund's returns. It pays to understand both the upsides and the downsides of any type of investing and the methods by which to choose products that match one's goals and tolerance for risk.

One particular example is a presentation conducted by financial services firms for individuals to review an individual's financial portfolio. Such a presentation is used to present to customers information about their portfolio. Conventionally, such a presentation is conducted either in a face to face meeting with the individual where the details of a portfolio is presented either on a paper copy or displayed on a computer monitor, e.g., viewing financial statements on-line.

When it comes to investing in mutual funds, investors have literally thousands of choices. Typically, a fiduciary or financial advisor, by listening to an investor or client's goal for retirement income and the like, aids the client in determining the most suitable investment portfolio to create over the course of years to come with periodic revisions to the portfolio. Despite the financial advisor's good intentions and efforts in attempting to aid the client in understanding his investment tools and products, the advisor is still merely armed with charts demonstrating the overall views of groups of funds without any revelation of details at a shorter term scale. At the opposite spectrum, there are charts that may be requested by a prospective client that often show significant falls and rises even over periods such as days, weeks and months and lack meaningful indicators showing general trends. Advertisements, rankings, and ratings often emphasize how well a fund has performed in the past. Studies show that the future is often different, especially in light of short term past results. For example, this year's “number one” fund can easily become next year's below average fund. The amount of time a fund has been in existence also has bearing on the reliability of past performance. Newly created or small funds sometimes have excellent short-term performance records. As these funds may invest in only a small number of stocks, a few successful stocks can have a large impact on their performance. However, as these funds grow larger and increase the number of stocks they own, each stock has less impact on performance. This may make it more difficult to sustain initial results. While past performance does not necessarily predict future returns, it can indicate the volatility of a fund over a period of time. Generally, the more volatile a fund, the higher the investment risk. If money is needed to meet a financial goal in the near-term, one probably cannot afford the risk of investing in a fund with a volatile history because there will not have enough time to ride out any declines in the stock market. It is therefore imperative to have funds evaluated at suitable periods, especially when regular contributions are made to such funds.

Volatility measures the variability in the price of an asset over time and is commonly calculated as annualized volatility without considering the link between this volatility and the client's financial goal. Common calculated data such as averages, standard deviations, highs and lows are often provided to provide a sense for volatility. Volatility measures are commonly tied to risks, i.e., the downturn that an individual can “tolerate.” All funds carry some level of risk and some clients may lose some or all of the money invested. In addition to the typical charts, there are personality profile evaluations that are geared towards estimating the amount of risk a client is willing to take. Although this may help in getting the client in line with the client's expectation, such profiles do nothing in establishing a goal and helping the client make decision based on the client's financial goal, e.g., in percentage gain, etc.

Product vendors and their paid salespeople generally control and often limit access to product information. Vendors typically do not want consumers of such financial products to have a practical way to objectively evaluate their products in comparison with those of others. Such an ability to objectively compare (i.e., comparatively evaluate) products being offered would effectively commoditize financial products, and would adversely impact the hoped for effect of the large advertising and marketing budgets of these large product vendors. Guarding against the risk that industry products such as mutual funds are not turned into commodities was listed as one of top challenges facing the Investment Company Institute's membership, as was stated in the Jun. 20, 2000 Financial Planning Journal of the Bureau of National Affairs.

Further, conventional performance reporting practices contain at least one fundamental flaw. The conventional standard performance reporting has been established by Chartered Financial Analyst (CFA®) Institute, the professional association for securities analysts which has become part of the Board of Certified Financial Planning (CFP) curriculum as well as the Institute of Certified Trust and Financial Advisor (CTFA) curriculum. Such reporting can be found in every Morningstar report and, since 2002, the Securities & Exchange Commission (SEC) now requires every mutual fund to include it in its prospectus.

The conventional performance reporting standard is the 1-year, 5-year and 10-year performance numbers portfolio managers report to the investing public. This conventional system was initially developed such that fiduciaries may be able to objectively compare different portfolios on a standardized basis. In addition, fiduciaries may be able to view the longer term performance of a fund and thus avoid making a decision based only on a single (especially short-term) period of time. The financial industry therefore concluded it should look at a wide range of universal performance reporting periods. This generally accepted principal led to the 1, 5 and 10-year performance reporting standard today. This broadly accepted standard however contains a significant flaw which can lead to potentially damaging results for the naïve investor or client and the fiduciary whose due diligence process incorporates the flaw. Such flaw is sometimes referred to as Snapshot-in-Time Anomaly. For years, professional portfolio managers have been aware of this flaw as they eagerly anticipated a bad performance year rolling out of a performance period over the course of time. The casual observer might brush this off as a matter already addressed by looking at the three different reporting periods. The damage caused by the flaw is most acute for long-term investors who contribute regularly to their portfolio. This includes nearly everyone who defers a portion of their wages into a retirement plan, and, most especially, to the plan trustees ultimately responsible for protecting plan beneficiaries.

U.S. Pat. Pub. 2009/0125450 of Mannion discloses a method and system for measuring investment volatility (e.g., total portfolio volatility of individuals) and/or investment performance (e.g., total portfolio performance of individuals). In one example, the method and system may be used for measuring investment volatility and/or investment performance of personal pension portfolios. In another example, the method and system may provide for measuring volatility of an investment portfolio held by an investor, comprising: providing first information indicating volatility of the investment portfolio over one or more predetermined periods of time; and providing second information indicating volatility of investment portfolios of the investor's peer group (e.g., on average) over the predetermined period(s) of time. This disclosure demonstrates a method and system by which volatility is measured. Again, it does not tie volatility in with a goal that is set by a client.

U.S. Pat. Pub. No. 2007/0038545 of Smith et al. discloses a consultation analysis for a 401 K retirement savings plan comprising a plurality of informational elements. Participant profiles are a first one of the informational elements and are provided for each one of a plurality of classes of participants in the 401 K retirement savings plan. A model portfolio is a second one of the informational elements and is provided for each one of the participant profiles. At least a portion of the model portfolios include a plurality of asset classes. Designation of a plurality of performance-quantified investment choices for each one of the asset classes is a third informational element. The performance quantified investment choices are performance-quantified with respect to at least one performance factor. Designation of a plurality of suggested ones of the investment choices for each one of the asset classes is a fourth informational element. This disclosure demonstrates the use of a complex set of parameters for facilitating management of 401 K retirement savings plan where such practice is more suited for financial professionals and not suitable for use as aids presented to clients for investment decision-making purposes.

Thus, there arises a need for a simple financial advisory system which can be readily used by a financial advisor to communicate investment choices to his or her clients such that the choices can be narrowed down and possibly eventually selected.

### SUMMARY OF THE INVENTION

The present invention is directed toward a system for providing investment metrics of an investment based on a multi-period time span, the system comprising:
(a) an apparatus for providing a first measure comprising a first ratio of the number of periods in which a return of the investment within the multi-period time span meets or exceeds a Goal Oriented Target (GOT) to the total number of periods within the multi-period time span; and
(b) an apparatus for providing a second measure comprising a second ratio of the total amount of surpluses within the multi-period time span to the total amount of surpluses and gaps within the total number of periods in the multi-period time span.

In one embodiment, the GOT is expressed in percentage point of the investment.

Accordingly, it is a primary object of the present invention to provide a financial advisory system which can be used to aid investors in allocating resources in assets by tying a client's financial goal with performance metrics that reflect the frequency and amplitude at which certain assets met and exceeded the financial goal in the past.

It is another object of the present invention to provide a financial advisory system which is simple, easily explainable to clients and thus enables clients to make educated choices in asset selection and/or allocation.

Whereas there may be many embodiments of the present invention, each embodiment may meet one or more of the foregoing recited objects in any combination. It is not intended that each embodiment will necessarily meet each objective. Thus, having broadly outlined the more important features of the present invention in order that the detailed description thereof may be better understood, and that the present contribution to the art may be better appreciated, there are, of course, additional features of the present invention that will be described herein and will form a part of the subject matter of this specification.

### BRIEF DESCRIPTION OF THE DRAWINGS

In order that the manner in which the above-recited and other advantages and objects of the invention are obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 depicts a conventional standard performance reporting of two funds.

FIG. 2 depicts a conventional annual performance reporting of two funds.

FIG. 3 depicts another conventional standard performance reporting of two funds.

FIG. 4 is a 5-year moving average of two funds, appropriately depicting the trends of two funds.

FIG. 5 is a table showing returns from two funds over several periods where the table is used to demonstrate the means by which the present frequency and amplitude are calculated.

FIG. 6 is another table showing returns from two funds over several periods where the table is used to demonstrate the means by which the present frequency and amplitude are calculated.

FIG. 7 is an example interface used for receiving client data and calculating a Goal Oriented Target (GOT) based on the data.

FIG. 8 are tables demonstrating the amounts of annual contribution needed to result in the asset sizes listed in the tables based on a range of percentages of return.

FIG. 9 is an example table listing several funds that have been short listed by a financial advisor and presented to a client for further selection of one or more funds from this short list.

### PARTS LIST

2—frequency
4—amplitude
6—value corresponding to worst 5-year period
8—value corresponding to break-even amplitude
10—Goal Oriented Target (GOT)
12—Fund A
14—Fund B

### PARTICULAR ADVANTAGES OF THE INVENTION

The present financial advisory system provides metrics, e.g., frequency and amplitude, which can reveal flaws which are otherwise hidden in conventional performance reporting practices. These metrics can be used to determine the most optimal investment choices to achieve a goal oriented target (GOT) calculated based on a client's retirement savings goal.

### DETAILED DESCRIPTION OF A PREFERRED EMBODIMENT

The term “about” is used herein to mean approximately, roughly, around, or in the region of. When the term “about” is used in conjunction with a numerical range, it modifies that range by extending the boundaries above and below the numerical values set forth. In general, the term “about” is used herein to modify a numerical value above and below the stated value by a variance of 20 percent up or down (higher or lower).

The term “Goal Oriented Target (GOT)” is defined as the percentage point return required by a client by the end of an investment period. The realistic GOT can range from about 2% to about 10%, although outliers may exist on either end of the spectrum.

The term “frequency” is used herein to mean the percentage of time in which an investment meets or exceeds a target. A frequency indicates how often the investment option met or exceeded a GOT. In this measurement, one does not care to what degree the investment option met or exceeded the GOT. One is concerned with whether one simply met or failed to meet the GOT. If an option met or exceeded the GOT only half the time, its frequency would equal 50%. Likewise, if the option met or exceeded the GOT all the time, its frequency would equal 100%.

The term “amplitude” is used herein to mean the likelihood of an investment of recovering from not meeting a target. An amplitude indicates to what degree a GOT is met or exceeded. In this measurement, one considers the degree to which one either met or failed to meet the GOT. One tries to get an idea of how much damage the failure to meet the GOT impacts one over time. As disclosed elsewhere herein, if the option met or exceeded the GOT only half the time, its frequency would equal 50%. This frequency indicates that one may have an equal chance of meeting or failing to meet the GOT. If the margin at which the GOT is missed equals the margin at which the GOT is surpassed, then the amplitude is 50%. However, if the GOT is missed by a wider margin than the GOT is surpassed, the amplitude falls below 50%. On the other hand, if the GOT is missed by a smaller margin than the GOT is surpassed, then the amplitude rises above 50%. Ideally, options that have amplitudes greater than 50% for any given GOT are preferred. Incidentally, if the option's frequency is 100% (i.e., it met or exceeded the GOT all the time), its amplitude would also be 100%.

The term financial advisor is used herein to mean a fiduciary, trustee or professional rendering financial advice or services to clients.

Disclosed herein is a system for providing investment metrics of an investment based on a multi-period time span, the system comprising:
(a) an apparatus for providing a first measure comprising the number of periods in which the return of an investment within said multi-period time span meets or exceeds a GOT divided by the total number of periods within said multi-period time span; and
(b) an apparatus for providing a second measure comprising the total amount of surpluses within the multi-period time span divided by the total amount of surpluses and gaps within the total number of periods in the multi-period time span.

For purposes of illustration but not limitation, the present examples are related to retirement calculations on mutual funds where contributions are regularly made, instead of a mere upfront, one time investment. It shall be understood that the present system may be applied to other investment instruments that are regularly priced, such as stocks, bonds, Exchange-Traded Funds (ETFs) and any other investment portfolios.

FIG. 1 shows a conventional standard performance reporting and comparison between two hypothetical substantially similar funds with a long-term investment objective. This represents a graphical depiction of the 10-year, 5-year and 1-year performance reporting periods required by the Securities & Exchange Commission (SEC). A typical fiduciary would take advantage of this information to compare the two funds. Most trustees would most likely invest in Fund B 14. The reason shall be obvious. Fund B has performed better than Fund A 12 in the most recent periods and equal to Fund A in the longest (10-year) period.

FIG. 2 depicts a conventional annual performance reporting which does not clearly discern the portfolio which offers the best potential. While Fund B has several 0% return years, however, when it performs, its performance exceeds the best performance of Fund A. Fund A, on the other hand, though resplendent with many positive years, does have a couple of bad years, including one significant negative year, i.e., at year 1994. The fact that regular contributions are made only complicates matters.

In looking at both performance charts of FIGS. 1 and 2, there may be a tendency to select Fund B. After all, it appears to both preserve wealth (it has no down years in FIG. 2) yet offers a comparable long-term return (FIG. 1 shows it has the same ten-year return as Fund A). Unfortunately, most retirement plans, most notably 401 k plans, feature regular contributions. Given this, what real-life impact would each fund's respective return have on a typical plan beneficiary? This practical question mimics the kind of decisions plan trustees across the nation must make every day. Assume that one must choose between Fund A and Fund B for one of these investment options. Without additional metrics, it would have been difficult to select one of the two funds to invest in.

FIG. 3 shows the impact periodic contributions have on the actual ending dollar value when investing the exact same amount in each fund ($8,000) at the beginning of each of the ten years of our study. Surprisingly, it has been discovered that a typical 401 k beneficiary would have $10,000 more to spend by investing in Fund A, despite each fund having an identical 10-year performance record. This difference could be quite substantial for the average employee investing in a 401 k retirement plan. Furthermore, to emphasize the critical issue of the timing of reporting periods, an employee that retired in 2000 (i.e., a year before the end of the reporting period), would have 26% more assets by investing in Fund A versus Fund B. The Securities and Exchange Commission (SEC) does not require funds or mutual fund rating organizations to present performance reporting data in a manner that is both relevant to and easily applicable to retirement plan trustees and their beneficiaries. This conventional way of looking at investment performance, though generally accepted by the government and industry, may inadvertently imperil fiduciaries and the investing public.

FIG. 4 represents a series of rolling 5-year performance returns (i.e., the 5-year moving average). For example, the bars entered above 1996 contain the returns for the period from 1992 to 1996. The bars entered above the space for 1997 contain the returns for the period from 1993 to 1997. Unlike FIG. 2, which shows distinct annual returns, FIG. 4 contains overlapping periods. The Applicant discovered that 5-year periods are minimum suitable time spans as they are the shortest generally recognized long-term periods in order to maximize the information yield based on the data available to the public (i.e., annual data). It shall be noted that while FIG. 4 may appear to contain less data than FIG. 1 (in particular, the 10-year total investment return) and FIG. 2 (ten years of annual investment returns), in fact, FIG. 4 contains the exact same performance data (but does so in a more revealing manner). A graph of rolling 5-year annualized performance returns offers a significant advantage for long-term investors, especially those who contribute regularly to their portfolios, (e.g., employees who defer a portion of their earnings into a 401 k plan). This type of graph quickly shows the investor the range of long-term returns that might be expected when investing recurrently over any period of time. For example, if an investment was made in 1995, in five years, the investment would yield more than 16% in Fund A versus about 10% in Fund B (this is represented by the bars above the year 1999—i.e., five years after the initial investment). By examining FIG. 4, the typical fiduciary, for example, would immediately see Fund A represents the more consistently attractive investment over time.

In general, Fund A outperforms Fund B in every rolling five-year period except for the last one; hence, the Snapshot-in-Time Anomaly that we saw earlier. This flaw is similar to the “blinker” problem encountered by securities analysts who screen for stocks. Very often, a stock will appear on last month's screen, but not on this month's screen. An analyst who does not regularly run screens might buy a stock that appears on a screen due only to the accident of timing. In the present example, the rolling five-year graph allows the trustee to see the results of several “screens” all on one graph. Therefore, a trustee who only looks at the most recent reporting period stands to make an unfortunate and potentially damaging investment decision. An investor who fails to undertake comprehensive due diligence only hurts himself or herself. A fiduciary who makes the same mistake unnecessarily exposes himself and his company to a liability that can otherwise be easily avoided.

Unfortunately, government and industry continues to employ the traditional performance reporting standard; thus, leaving the investing public and fiduciaries vulnerable and vastly uninformed. As a result, until a new standard is adopted, smart fiduciaries who seek to conduct the necessary due diligence must create sometimes complicated spreadsheet algorithms to extract rolling five-year charts. Upon reading the ensuing disclosure, it shall be apparent that the Applicant has provided metrics and a system for providing such metrics which can aid a financial advisor and a client in making informed investment decisions.

FIG. 5 is a table showing returns from two funds (X and Y) over several periods where the table is used to demonstrate the means by which the present frequency and amplitude are calculated. In calculating a frequency and amplitude, returns on an investment for a number of periods in the past are obtained. For instance, if a retirement calculation is to be made, the number of years in which contributions (number of years to retirement) are to be made may be taken as the number of periods.

In this example, the returns of funds X and Y in the past five periods are 60, 140, 90, 180, 20 and 80, 100, 120, 140, 150, respectively. The magnitude of each number represents the size of a return. In order to achieve a GOT of K %, the return expected is 100, 110, 120, 130, and 140 for Period 1, 2, 3, 4, and 5, respectively. Frequency can be further expressed as the number of periods in which the return of an investment within the total number of periods under consideration meets or exceeds GOT divided by the total number of periods (e.g., 5 in this example) under consideration. Frequency can be further represented as follows:

Frequency=Σ(#Periods when Return≧GOT)/Σ(#Periods)

Therefore, frequencies of X and Y are ⅖ or 40% and ⅗ or 60%, respectively. Considered singly, frequency Y is viewed more favorably as it is higher than frequency X.

Amplitude can be expressed as the total amount of surpluses within the total number of periods under consideration divided by the total amount of surpluses and gaps within the total number of periods under consideration. Amplitude can be further represented as follows:

Amplitude=Σ((Return−GOT)if Return≧GOT)/Σ|Return−GOT|

Where amplitude X=((140−110)+(180−130))/(|(60−100)|+|(140−110)|+|(90−120)|+|(180−130)|+|(20−140)|)=29.6%

and amplitude Y=((120−120)+(140−130)+(150−140))/(|(80−100)|+|(100−110)|+|(120−120)|+|(140−130)|+|150−140)|=40%

In the examples disclosed herein, frequencies and amplitudes are expressed in percentage points, as such use is in line with the percentage gain of an investment, e.g., mutual funds, stocks and other financial instruments. Considered singly, amplitude Y again, is viewed more favorably as it is higher than amplitude X. A surplus is defined as the difference between a return and the value corresponding to a GOT when the return is greater than the value corresponding to the GOT. A gap is defined as the difference between a return and the value corresponding to a GOT when the return is less than the value corresponding to the GOT.

FIG. 6 is another table showing returns from two funds over several periods where the table is used to demonstrate the means by which the present frequency and amplitude are calculated. Note that the past return X has been altered to a value of 200 in Period 2 instead of the value of 140 as in FIG. 5. Applying the same formula disclosed elsewhere herein, the following frequency and amplitude result. Frequencies X and Y are ⅖ or 40% and ⅗ or 60%, respectively. Amplitude X remains unchanged at 40%. Amplitude is calculated below.

Amplitude X=((200−110)+(180−130))/(|(60−100)|+|(200−110)|+|(90−120)|+|(180−130)|+|(20−140)|)=42.4%

Note that although the frequency X is still lower than frequency Y, amplitude Y is now higher than amplitude X. In other words, although X does not meet or exceed target as often as Y, but when it does, it meets or exceeds target with higher margins. It is therefore imperative, in light of the above examples that frequency and amplitude shall be considered simultaneously.

FIG. 7 is an example interface used for receiving client data and calculating a GOT based on the client data. This interface is configured to receive information such as the current salary, present value of retirement savings, current annual contribution, number of years until retirement, projected retirement income need, reduction in retirement need due to social security, reduction in retirement need due to pensions, reduction in retirement need due to outside income. Based on the data provided, in order to achieve an adjusted retirement savings goal of $177,800 in 7 years, a GOT of 5.22% is necessary. In a preferred embodiment as shown herein, GOT is expressed in percentage point adjusted retirement savings goal. Again, the use of percentage point in GOT is in line with the percentage gain of an investment, e.g., mutual funds, stocks and other financial instruments.

FIG. 8 are tables demonstrating the amounts of annual contribution needed to result in the asset sizes listed in the tables based on a range of percentages of return. These charts are typically supplied along with an interface, e.g., one disclosed on FIG. 7 such that a client, at an initial meeting with a financial advisor, may, at a glance, determine the amount of annual contribution that will need to be made in order to achieve a certain GOT. For instance, for a span of 10 years to retirement, in order to achieve 8% GOT, an annual contribution of $6,000 will be necessary. As another example, for a 2% GOT, an annual contribution of $2000 will result in a total of $10,408 at the end of the fifth year.

Upon receiving the GOT as shown in FIG. 7, a financial advisor is ready to present choices of investment instruments such as mutual funds and stocks to the client. FIG. 9 is an example table listing several funds that have been short listed by a financial advisor and presented to a client for further selection of one or more funds from this short list. In FIG. 9, an example of twelve funds grouped in four fund groups are presented to the client. The client may choose to allocate his or her asset in one or more of these groups. A financial advisor typically works with a plurality of funds ranging from high risk with potentially high reward to conservative funds, i.e., a spectrum catering to investors willing to consider taking various levels of risks. The fund groups are represented by “Default,” “Lifestyle Asset Allocation,” “Traditional Long-Term Growth” and “Do-It-Yourself Asset Allocation.” The frequency 2 and amplitude 4 of each fund are calculated and listed under a GOT representing a typical GOT 10 value as a result of the “expected” GOT 10 calculation made in FIG. 7. In this case, frequencies 2 and amplitudes 4 are calculated for GOTs 10 corresponding to an inflation rate, 6%, 8% and 10% as these are commonly referenced values and a client, upon being introduced to such metrics may quickly grasp the meaning of such data and be able to use it to make informed decisions on his or her investment choices, such as selecting one fund over another. Referring back to and using the calculated GOT of 5.22% in FIG. 7, the closest GOT data that can be used for evaluating the funds is the GOT=6% data. For instance, if the client is interested in evaluating “MCVF” and “MCGF,” the client may quickly notice that both the frequency and amplitude of MCGF (83.33%, 88.33%) are higher than those of MCVF (48.33%, 87.15%) and therefore MCGF should be viewed more favorably than MCVF. However, when the worst 5-year data 6 is examined, it shall be noted that the −4.44% of MCGF is worse than the −0.21% of MCVF as the value of −4.44% is more negative than the value of −0.21%.

In one embodiment, a knowledge base including a plurality of expert rules is established in a computing device for evaluating and selecting an investment based upon the inventor's GOT. A ranked listing of investments can be generated based upon the frequencies and amplitudes obtained. For instance, a scoring system employing a weighting scheme may be applied to a frequency and its corresponding amplitude. In one example, a score is the total of (K1*frequency) and (K2*amplitude) where K1 and K2 are weighting factors. Various expert rules may be applied where the expert rules reflect the importance an investor places on financial factors. For instance, a reserved investor may choose a larger K1 value as the consistency in performance is more important than potentially high risk (and/or high volatility) but potentially high reward type of investment. On the other hand, an investor willing to take risk may tolerate a smaller K1 for a higher K2. As a result of applying expert rules, one or more ranked listings of investments can be generated for an investor to facilitate investment decisions.

In one embodiment, a break-even amplitude 8 is further provided. This is an approximation of a particular annual return at which the degree by which a GOT is missed is exactly offset by the degree by which the GOT is surpassed. This is the annual return at which the amplitude equals 50% and represents the return at which one has an even (i.e., 50%) chance of meeting the GOT by investing regularly in the specific investment option being analyzed. The break-even amplitude 8 of each fund provides a basis upon which its amplitude can be compared to such that a sense of “how much better than average” can be gleaned from such comparison. A greater departure of an amplitude from its break-even amplitude, the more favorably the amplitude is viewed.

In yet another embodiment, a worst period is further provided. This is the lowest annual return that an option meets or exceeds a GOT all the time, i.e., with its frequency equal to 100%. In other words, it is the worst return experienced in any five-year rolling period over the entire time span reviewed. The Applicant discovered that by further providing any one of these two measures, a client can better grasp the meaning of amplitude as the break-even amplitude represents an “average” return within the multi-period under consideration while the worst period represents the worst case that happened within the multi-period under consideration.

Referring back to FIG. 5, the break-even amplitude is obtained by iterating the target return corresponding to GOT=K % until the amplitude arrives at 50%. For instance, in order to calculate the break-even amplitude of X, the target return corresponding to GOT=K % is adjusted down to 99 such that an amplitude can be calculated for X. If such amplitude is 50%, a break-even amplitude has been found. If such amplitude is not 50%, the target return corresponding to GOT=K % may be further adjusted down to 98 such that an amplitude can be calculated again for X. This process is repeated until a 50% amplitude is found. Referring back to FIG. 5, the worst periods for X and Y are period 5 and period 1, respectively. The return corresponding to the worst period may also be presented as a percentage point by contrasting the return (20 for X and 80 for Y) of the worst period with the target return corresponding to GOT=K %. Likewise, the break-even amplitudes of X and Y may also be contrasted with their respective target return corresponding to GOT=K % such that they may be presented as percentage points.

The detailed description refers to the accompanying drawings that show, by way of illustration, specific aspects and embodiments in which the present disclosed embodiments may be practiced. These embodiments are described in sufficient detail to enable those skilled in the art to practice aspects of the present invention. Other embodiments may be utilized, and changes may be made without departing from the scope of the disclosed embodiments. The various embodiments can be combined with one or more other embodiments to form new embodiments. The detailed description is, therefore, not to be taken in a limiting sense, and the scope of the present invention is defined only by the appended claims, with the full scope of equivalents to which they may be entitled. It will be appreciated by those of ordinary skill in the art that any arrangement that is calculated to achieve the same purpose may be substituted for the specific embodiments shown. This application is intended to cover any adaptations or variations of embodiments of the present invention. It is to be understood that the above description is intended to be illustrative, and not restrictive, and that the phraseology or terminology employed herein is for the purpose of description and not of limitation. Combinations of the above embodiments and other embodiments will be apparent to those of skill in the art upon studying the above description. The scope of the present disclosed embodiments includes any other applications in which embodiments of the above structures and fabrication methods are used. The scope of the embodiments should be determined with reference to the appended claims, along with the full scope of equivalents to which such claims are entitled.

I claim:

1. A system for providing investment metrics of an investment based on a multi-period time span, said system comprising:
(a) an apparatus for providing a first measure comprising a first ratio of the number of periods in which a return of the investment within the multi-period time span meets or exceeds a Goal Oriented Target (GOT) to the total number of periods within the multi-period time span; and
(b) an apparatus for providing a second measure comprising a second ratio of the total amount of surpluses within the multi-period time span to the total amount of surpluses and gaps within the total number of periods in the multi-period time span.

2. The system of claim 1, further comprising an apparatus for providing a break-even amplitude, wherein said break-even amplitude is a return corresponding to said second measure at 50%.

3. The system of claim 1, further comprising an apparatus for providing a worst period, wherein said worst period is a return corresponding to said first measure at 100%.

4. The system of claim 1, wherein said multi-period is at least a 5-year period.

5. The system of claim 1, wherein said first measure is expressed in percentage point.

6. The system of claim 1, wherein said second measure is expressed in percentage point.

7. The system of claim 1, wherein said investment is selected from an investment instrument consisting of mutual funds, stocks, bonds, Exchange-Traded Funds (ETFs) and any other investment portfolios.

8. A method for providing investment metrics of an investment based on a multi-period time span, said method comprising:
(a) providing a first measure comprising a ratio of the number of periods in which a return of the investment within the multi-period time span meets or exceeds a Goal Oriented Target (GOT) to the total number of periods within the multi-period time span; and
(b) providing a second measure comprising a second ratio of the total amount of surpluses within the multi-period time span to the total amount of surpluses and gaps within the total number of periods in the multi-period time span.

9. The method of claim 8, further comprising providing a break-even amplitude, wherein said break-even amplitude is a return corresponding to said second measure at 50%.

10. The method of claim 9, wherein said break-even amplitude is obtained by iterating said second measure until said second measure measures 50%.

11. The method of claim 9, further comprising providing a worst period, wherein said worst period is a return corresponding to said first measure at 100%.

12. A method for guiding the selection of an investment for an investor with a known Goal Oriented Target (GOT), wherein said GOT is a percentage point return required by a client by the end of an investment period of the investment, said method comprising:
(a) providing financial performance information to a computing device, said financial performance information comprises financial performance information of a multi-period time span wherein a period of said multi-period time span is selected from the group consisting of 10-year, 5-year, 1-year and combinations thereof;
(b) generating in said computing device, a first numerator representing the number of periods in which a return of the investment within said multi-period time span meets or exceeds said GOT;
(c) generating in said computing device, a first denominator representing the total number of periods within said multi-period time span;
(d) generating in said computing device, a first ratio of said first numerator to said first denominator;
(e) generating in said computing device, a second numerator representing the total amount of surpluses within said multi-period time span;
(f) generating in said computing device, a second denominator representing the total amount of surpluses and gaps within the total number of periods in said multi-period time span;
(g) generating in said computing device, a second ratio of said second numerator and said second denominator;
(h) providing information to a computing device, said information comprising a knowledge base comprising a plurality of expert rules for evaluating and selecting an investment based upon the inventor's GOT; and
(i) generating in said computing device, a ranked listing of investments for the investor based on application of said plurality of expert rules on said first ratio and said second ratio.

13. The method of claim 12, further comprising providing a break-even amplitude, wherein said break-even amplitude is a return corresponding to said second ratio at 50%.

14. The method of claim 13, wherein said break-even amplitude is obtained by iterating said second ratio until said second ratio measures 50%.

15. The method of claim 13, further comprising providing a worst period, wherein said worst period is a return corresponding to said first ratio at 100%.
